(19) United States
(12) Patent Application Publication
(10) Pub. No.: US 2013/0019493 A1
(43) Pub. Date: Jan. 24, 2013

(54) METHOD OF PROCESSING AND DRYING WASTE IN A CYCLIC CONTINUOUS PROCESS

(71) Applicants: Gedalyahu Manor, Haifa (IL); Gadi Amitai, Haifa (IL)

(72) Inventors: Gedalyahu Manor, Haifa (IL); Gadi Amitai, Haifa (IL)

(73) Assignees: TNA SYSTEMS LTD., Haifa (IL); AIRGREEN LTD., Haifa (IL)

(21) Appl. No.: 13/638,153

(22) PCT Filed: Mar. 27, 2011
(86) PCT No.: PCT/IL11/00277

§ 371 Date: Sep. 28, 2012

(30) Foreign Application Priority Data
Mar. 28, 2010 (IL) 204790

(51) Int. Cl. F26B 7/00; F26B 19/00

(52) U.S. Cl. 34/386; 34/60

(57) ABSTRACT

The present invention is directed to a device for drying waste in a continuous cyclic process. The invention is further directed to a method for drying waste in a continuous cyclic process in the device of the invention, wherein the raw waste entering the system is at a vast range of moisture contents between 99% and 75%.

### FIELD OF THE INVENTION

This invention relates to a method and devices for drying waste in a closed loop cyclic continuous process.

### BACKGROUND OF THE INVENTION

Wastes are separated as sludge from several waste streams among others: sludge from municipal waste water plants, industrial waste water, municipal solid waste [MSW], any kind of hazardous waste and manure from livestock production facilities. The wastes are wet, in most cases, have undesired smell and pollute the ground and ground water by leached water from them. The wastes may have nutrients good for agricultural crops, or other substances that may be recovered or recycled. The wastes need some biochemical and/or drying process to enable environmentally and economically disposal. The present disposal alternatives include among other spreading on agricultural fields, landfills and incineration. The organic wastes can be used as energy source, but need some biochemical and/or drying process to be used economically for that.

Several manufacturers are drying sludge by using belts and/or rollers to help in extracting the moisture out of the waste when the sludge is wet and exposing more surface area to the drying air at all stages of drying. Others utilize heated or unheated screws with or without the assistance of hot air.

One significant obstacle of the existing methods lays at the first drying stage, where wet sludge is bulky and tough to dry, resulting in economically inefficient process.

It is an object of the invention to provide a method and devices for drying the waste in a cyclic closed loop continuous process, while maintaining homogeneous sludge properties all over the sludge cavity, where wet sludge is continuously mixed with relatively large quantities of dry sludge, forming a mixture that is optimally dryable. Here lumps of the waste exposed to hot and dry air allowing large surface area of the waste in contact with the air. The mixture of dry and wet lumps together with large surface area enhances the drying process and makes it economically efficient.

The dry waste coming out of the process will be readily available for disposal. The dry waste has more environmental and economical benefits: a] while being spread in agricultural fields it will reduce soil and water pollution and increase its nutrient value as fertilizer b] in the event of waste used as energy source, it will require less heat in the energy generation process at a lower disposal cost.

### SUMMARY OF THE INVENTION

The invention provides a method for drying the waste in a cyclic closed loop continuous process, while maintaining homogeneous sludge properties all over the sludge cavity. Wet sludge is diffused evenly over the surface of the dry sludge and consequently reduced in size and mixed with relatively large quantities of dry sludge. The resulting mixture of small size large surface dry and wet lumps is optimally dryable. Here lumps of the waste exposed to hot and dry air allowing large surface area of the waste in contact with the air. The mixture of dry and wet lumps together with large surface area enhances the drying process and makes it economically efficient the lumps undergo size reduction and mixing thus allowing maximization of the vapor transfer rate between the hot/dry air and the waste.

The wastes to be processed may be sludge from sewage treating facilities, municipal solid waste [MSW], industrial waste any kind of hazardous waste and manure from livestock production facilities. The process starts with pumping of the wet sludge to the sludge diffuser. On the way to the diffuser the sludge is heated and pressurized. The diffuser/ feeder feeds the chamber cavity with a continuous flow of lumps of wet or partly dried waste with maximal surface area, evenly spread over the drying layer of dry sludge. The pre water extraction process in the diffuser/feeder is done by pressurized heating the waste, resulting in flushing-like fast drying and granulating of the wet sludge while diffused to ambient pressure. The feeding flow rate of the dry sludge is designed to maintain constant volume of sludge at the cavity, so by nature it is always equal to the indeed rate of the wet sludge. The in feed capacity is set by the operator according to the intake sludge conditions and the discharge sludge requirements.

The size reduction mixing mechanism, with or without throwing forward, mix the wet lumps with the already dry lumps of waste and reduces the size of too large lumps, generating easy to dry homogeneous mixture with maximal surface area exposed to the drying air.

Drying air can be fed on top of the sludge layer and from any other direction as well as needed for further enhancement of the drying process. After being dried, the waste is being collected and conveyed to a transporting device or to an energy generator, using the dry waste as a source.

The continuous flow of waste according to the invention may be performed by at least one lumps diffuser/feeder above the floor.

The continuous lumps diffuser/feeder is a high pressure waste pump and high temperature heated pipes at the end of which is a granulating flush diffuser, providing small, high surface lumps. The intensive dewatering effect is made by steam flushing at the discharge of the diffuser.

In another embodiment, the continuous lumps feeder is a screw conveyor, cylindrical or conical, inside a perforated housing of the same shape, forcing the waste outside the holes while cutting them into individual lumps.

In another embodiment, the drying air circulates at high flows on to contact with the sludge and back to the heating zone.

In another embodiment, the drying air is heated by the residual heat from heating the diffuser/feeder.

In another embodiment, drying air is blown through nozzles located at the sides and or at the bottom of the sludge layer for further enhancement of the drying rate.

In another embodiment, the exhaust air flow rate is adjusted according the desired moisture content, as calculated to provide optimal drying.

In another embodiment, the exhaust air hood is located on top of the flushing steam coming out of the diffuser/feeder, resulting in lower exhaust air quantities.

In another embodiment, the at least one set of size reduction and mixing mechanism, based on rotating blades, moves through the stationary layer of waste forward while mixing the lumps at different depth.

In another embodiment, the residual dry waste discharged outside the cavity to the outside, by at least one top scraper supported by screw conveyor.

In another embodiment, the dry waste is collected by at least one top scraper without screw conveyor, out of the chamber.

In another embodiment, the cavity bottom rotates in circular cyclic manner. With lumps of waste while the feeding device; the size reduction and mixing mechanism and the discharge device are stationary.

In another embodiment, the rotating cavity bottom is composed of sections of a conveyor.

In another embodiment, the continuous cyclic drying of waste is performed by a stationary bottom while the feeding device; the size reduction and mixing mechanism and the discharge device are rotating.

The drying process according to the invention may be controlled by a computerized control system, using sensors to measure the different parameters like the temperatures of the waste and the air, at different points. The remote computer collects the processed data for analysis and optimization.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is an over all cross section view of the insulating drying chamber

FIG. 2 is an over all top view of the concentric cylinders drying chamber

FIG. 3 is a view of the heating method including the heating chamber and the granulating flush diffuser/feeder.

### DETAILED DESCRIPTION OF EMBODIMENTS

The invention will now be described by referring to the following none limiting figures. Turning to FIG. 1, there is described a cross section of the “cylinder in cylinder” insulated drying chamber. Wet sludge enters at pipe 13 at high pressure and continues into the burning chamber 3, where it is heated via direct flame burner 9, and with the aids of fins 2. high pressure and high temperature sludge leaves the burning chamber to the flushing diffuser 11, where the steam flushes out of the sludge into the ambient pressure. Flush steam 23 sucked out of the chamber via hood 10. The diffused sludge falls down onto the rotating 22 circular cavity bottom 7, on top of the dry sludge layer 14. While rotating, the sludge is exposed to hot 15 air jet generated at several blower units 4 with external motors. The, the air entering the blowers 16 is heated while passing through the outside of the burning chamber 3, utilizing the excess heat generated there and using the burned gases leaving the burning chamber 17. Drying air 18 leaving the sludge is circulated back to the burning chamber. Excess air leaves the chamber via hood 10, which is regulated for optimal drying costs. The rotation of the cavity 7 brings the sludge to the mixer-cutter 8 which is responsible for breaking of the top layer of the newly entered sludge and for mixing bottom cavity sludge with top cavity sludge and throwing it forward, generating homogeneous sludge cross section. Following mixing the discharge mechanism 5 scrapes out the top sludge layer, i.e., dry sludge, and keeping cavity sludge volume constant. Operator hatch and view holed 6 are used for monitoring with the help of control unit 12.

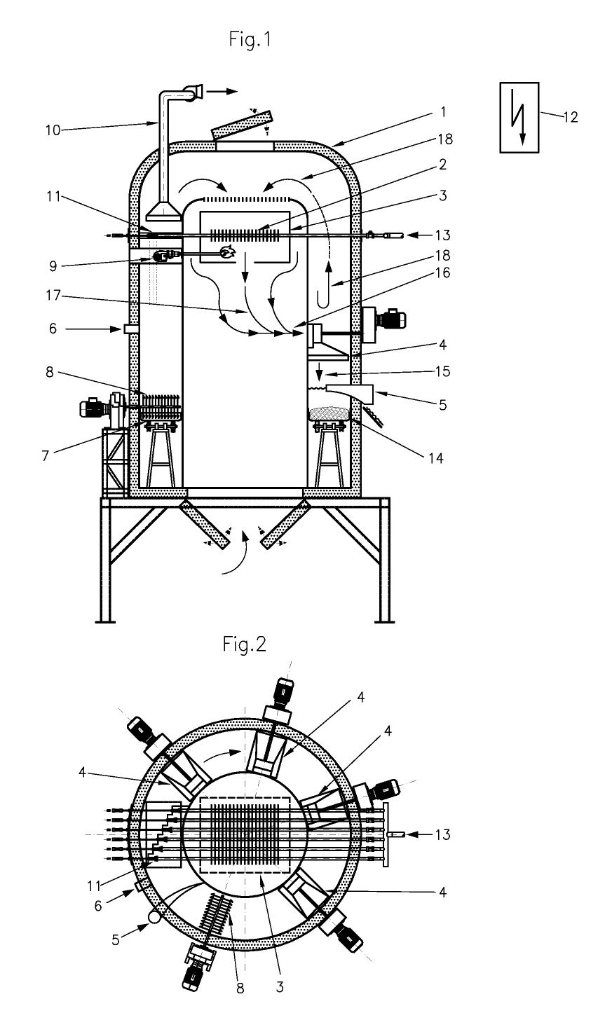

Turning to FIG. 2 there is described a top view of the concentric cylinders drying chamber, where intake sludge is at pipe 13, passing trough to diffusers 11 burner chamber 3, rotated 22, mixed at mixer 8 and discharged at discharge 5. Air drying nozzles 4 are located along cavity cycle.

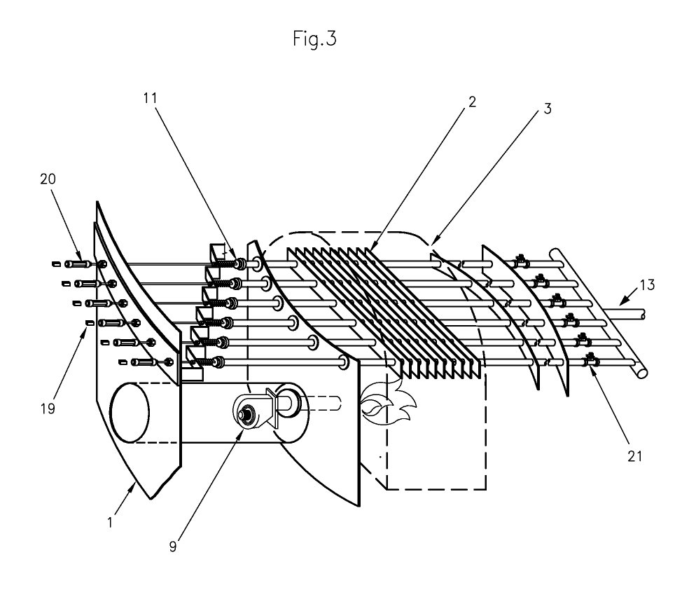

Turning to FIG. 3 there is described a partial perspective view of the heating method including the heating chamber and the granulating flush diffuser/feeder. Wet sludge enters pipe 13 at high pressure. Control valves 21 are used for pulsating operation, for flow validation and for cleaning. Sludge pipes enter the burning chamber 3 and heated via direct flame, generated by the burner 9. Fins 2 enhance the heating. Diffuser nozzles 11 maintain back pressure at the sludge pipe and up to the diffusion point back pressure and dynamic characteristics of the diffuser are regulated outside the chamber 1 via regulator 20. Detectors 19 detect the actual operation of the diffuser.

1. A device for drying waste in a continuous cyclic process comprising of:
(1) a feeding system for wet waste including in line direct heating of the sludge while flowing in the pipe and consequently flushing the steam out of the sludge via specially designed diffuser system:
(2) a cavity containing large amount of dry sludge continuously circulating while homogeneously mixed with smaller portion of wet sludge, where all of this mixture is dried up by hot air:
(3) size reduction and mixing devices, controlled and adapted to allow efficient waste cutting and mixing enabling throwing waste lumps in the air.
(4) collecting and discharging system designed to remove excess amount of dry waste out of the system, where discharge rate is derived automatically from the current amount of sludge in the cavity.

2. The device of claim 1, wherein said feeding and diffusing system comprising direct flame, in pipe heating of wet sludge up to high temperatures at high pressure, where the consecutive diffusion into ambient pressure causes the water to flush out of the waste at the form of steam thus consequently generating fluffy-like easy to dry sludge particles.

3. The device of claim 2, wherein the wet sludge undergoes diffusion and flushing process prior to entering the drying cavity for further drying.

4. The device according to claim 2 causing the diffused sludge to explodes when exposed to barometric pressure thereby puffing water out in the form of steam.

5. The devices of claim 2, wherein the diffuser system consists of pressure regulated discharge orifice, maintaining the desired back pressure at the heating zone, preventing steam flushing inside the pipe at any time.

6. (canceled)

7. The devices of claim 2 wherein in case of clogging or no flow situation, an automatic retraction of the conical pressure regulating system generates instantaneous large opening, releasing the clog.

8. The devices of claim 2 wherein the pipes of the diffuser system are heated by any hot gaseous media, inclusive of direct flame of gas burner, being the most cost effective and allowing the burning of undesired gases as well.

9. The device of claim 1, where the cavity is either of circular shape or rectangular shape with set of conveyors, within an enclosed and insulated chamber, where electric and other sensitive items are outside the chamber, while the internal mechanism is robust and can endure tough and hot operating conditions.

10. The device of claim 1, wherein the cyclic processing is obtained by moving the size reduction and mixing devices, along the cavity closed loop floor, e.g., circular floor or any other device enabling cyclic motion.

11. The device of claim 1, wherein the cyclic processing is obtained by moving the bottom of the cavity towards the size reduction and mixing devices that stays stationary, either by rotating the circular floor or by consecutive conveyors arranged in closed loop manner.

12. The device of claim 1, wherein the wet sludge is optionally dried up via reusing hot air residues from the direct heater chamber of the flush diffuser system, thus increasing energy efficiency.

13. A method for drying waste in a continuous cyclic process in the device of claim 1, wherein the raw waste entering the system is at a vast range of moisture contents: between 99% and 75%.

14. A method for drying waste in a continuous cyclic process in the device of claim 1, wherein the raw waste entering the system contain hazardous gases as well, that shall be blown through the direct flame chamber and may be moderately burned and/or oxidized while passing through the flame or by being in contact with the heated walls of the burning chamber.

15-16. (canceled)

17. A method for drying waste in a continuous cyclic process in the device of claim 1, wherein the source of the said hot air is a nearby institution with surplus heat of various natures and temperatures may be used in the system which is tolerant and flexible related to the usage of various energy types.

18. A method for drying waste in a continuous cyclic process in the device of claim 1, wherein the diffusion of raw sludge and the mixing of large amounts of dry sludge with small amounts of wet sludge, prevent the problematic treatment of wet sludge, as known in existing systems.

19. A method for drying waste in a continuous cyclic process in the device of claim 1, wherein the heating is done by direct flame or by direct usage of any other residual heat source, thus enabling system flexibility and energy saving.

20. A method for drying waste in a continuous cyclic process in the device of claim 1, wherein the heating is done by direct flame , while the residual heat is used for cavity sludge heating, thus saving energy costs.

21. A method for drying waste in a continuous cyclic process in the device of claim 1, wherein heating done by direct flame and the robust structure of the cavity, enables burning and oxidizing of moderated amounts of flammable and even explosive gases and enables reducing odors and eliminating the need for odor treatment.

22. The device of claim 1, comprising the discharge hood located such that the steam flushing out the diffuser is immediately sucked and discharged out of the chamber at the same spot of flushing, where moisture content is the highest in the hole system, and where this spot is at lower pressure so used as the overall wet air discharge as well.

23. (canceled)

24. The device of claim 1 wherein the discharged waste is composed of large amounts of dry waste and much smaller amounts of less dry waste, recently diffused into the cavity.

25. (canceled)
